(19) United States
(12) Patent Application Publication
(10) Pub. No.: US 2012/0090869 A1
(43) Pub. Date: Apr. 19, 2012

(54) EQUIPMENT CABINET WITH STIFFENED DESIGN FOR EARTHQUAKE RESISTANCE

(75) Inventors: Gerhard BUMEDER, Ottering (FR); Alfons KALTENBERGER, Simbach (DE); Josef KNAB, Rossbach (DE); Ralf PAEPCKE, Aidenbach (DE); Werner SPATENEDER, Pfarrkirchen (DE)

(73) Assignee: Knuerr GmbH, Arnstorf (DE)

(21) Appl. No.: 13/253,111

(22) Filed: Oct. 5, 2011

(30) Foreign Application Priority Data
Oct. 14, 2010 (DE) 10 2010 048 503.9

(51) Int. Cl. H02B 1/54

(52) U.S. Cl. 174/50

(57) ABSTRACT

In order to create a cabinet with a particularly simple earthquake construction, in which the necessary earthquake resistance and a static carrying load or respectively load capacity of up to 800 kg are guaranteed, cost-effectively producible stiffening panels are arranged and connected to form a body. The earthquake construction consists of a front and rear stiffening panel which are formed respectively as a frame and releasably connected to a bottom fixing angular element. Side stiffening elements are arranged between the front and rear stiffening panel which can be formed as one-part or multi-part, closed or interrupted panels.

The invention relates to an equipment cabinet with earthquake stiffening and is suitable for equipment cabinets with a load capacity of up to approximately 400 kilograms and also for cabinets with a higher load capacity, for example up to 800 kilograms.

Equipment cabinets are thereby understood to be switching and electronic cabinets, server cabinets and similar as used in computer centres, in telecommunications and in network technology.

Particularly in applications in the field of data technology cabinets are necessary which must satisfy a predefined carrying load or load capacity due to the increasingly heavy servers.

EP 0 686 316 B1 discloses an equipment cabinet with a base frame comprising transverse profiles, depth profiles and vertical profiles which are connected using corner connectors. As panelling parts side walls, a bottom cover or a base, an upper cover, a front door and a rear door or a rear wall as well as horizontal and vertical fixing struts for a step-free or 19″ or 25 mm matrix fixing of electrical module units, servers and similar are thereby fixed to the base frame. Generally the transverse, depth and vertical profiles of the base frame consist of aluminium or steel and have a uniform cross-section.

For heavy-duty cabinets, for example heavy-duty server racks, which have a static load in case of stationary implementation of 15,000 N, more stable profiles and reinforced corner connectors or corner nodes are used (prospectus of KNUERR AG “Miracel®—Schrankplattformen für Rechenzentren, Telekommunikation and Netzwerktechnologie, April 2007). In case of installation on ships or in trains and in particular in areas at risk of earthquakes the equipment cabinets must also withstand the increased dynamic loads and have a high vibration, shock or earthquake resistance. Cabinets and housings for receiving electrical and electronic components and module units must fulfil the requirements upon network systems according to Section 4.4 of the Telcordia Standard GR-63-CORE for use in areas at risk of earthquakes.

A heavy-duty version with a framework comprising defined hollow chamber profiles for a maximum static load of up to 800 kilograms and an earthquake resistance up to zone 3 is described in the internet publication of Schroff GmbH “Varistar—Electronikschrank-plattform”. Through additional reinforcing angular elements which must be welded in the corners of the frame an earthquake resistance up to zone 4 is to be guaranteed.

From DE 199 10 520 A1 an equipment cabinet with a framework and an additional auxiliary frame comprising vertical frame profiles and transverse struts is known. The auxiliary frame is to serve as an earthquake-proof auxiliary frame, whereby a front and a rear auxiliary frame are to be fixed to a front and rear region of the frame of the electronic housing or the equipment cabinet or else at a distance from this framework. In addition horizontal perforated strips between the front and rear auxiliary frame or between the vertical profiles of the framework for an additional stiffening of the cabinet are described.

A switching cabinet with a base and a framework, of which the torsional strength is to be improved by arranging stiffening angular elements and additionally connecting struts in the lateral corner regions of the framework, is described in DE 196 15 759 A1. The vertical frame legs on both sides and on the rear side of the framework are to be connected with each other using at least one pair of opposingly inclined struts.

Diagonal strutting for stiffening an equipment cabinet or the framework thereof and/or the panelling parts are also described in DE 27 36 163 A1 and DE 31 01 664 A1.

An equipment cabinet with horizontal side stiffening elements which are L-shaped and comprise openings and are also arranged between the vertical profiles of the framework is known from US 2001/0036399 A1. The usual bottom fixing of the earthquake-proof equipment cabinet by means of base plates and fixing points on the floor of the installation space of the cabinet is also described here.

The known cabinet constructions do not satisfy in each case the requirements for earthquake-proof or earthquake-suitable equipment cabinets, in particular with a load capacity of over 400 to 500 kilograms, in particular up to 800 kilograms. The stiffening components often require a relatively time-consuming assembly and welding. In addition relatively high-resource bottom fixtures are necessary and it is no longer possible to equip a cabinet as a base cabinet and simultaneously as an earthquake cabinet without having to change the base frame.

It is the object of the invention to create an equipment cabinet with earthquake stiffening which guarantees with simple construction and production the necessary earthquake resistance and static carrying load or load capacity up to approximately 800 kilograms.

The object is achieved according to the invention through the features of claim 1. Useful and advantageous embodiments are described in the sub-claims and in the description of the figures.

A core idea of the invention can be seen in using panels as earthquake stiffening and arranging these within the base frame of the equipment cabinet to form a stable and secure stiffening construction.

According to the invention the earthquake stiffening comprises a front stiffening panel and parallel thereto a rear stiffening panel as well as side stiffening elements. The side stiffening elements which are advantageously also formed as panels are connected to the front and rear stiffening panel so that a body is formed which constitutes a very stable reinforcing cage and can absorb great forces.

At least the front stiffening panel is usefully formed frame-like so that the access to the receiving area of the cabinet is guaranteed via a front access opening.

The rear stiffening panel can be formed virtually identically to the front stiffening panel and also in the manner of a frame. With the formation of a rear cable area it is useful to arrange the rear stiffening panel at a distance from the rear side of the rack or base frame of the cabinet.

It is advantageous for a direct introduction of force from the front and rear stiffening panel into the floor of the installation space of the cabinet or into the fixing points of the cabinet on the floor that bottom fixing angular elements are provided, on which the front and rear stiffening panels can be fixed and which for their part can be connected, in particular via a screw connection, to the fixing points of the cabinet on the floor of the installation space. A releasable fixing of the bottom fixing angular elements to the floor and also of the front and rear stiffening panel to the respective fixing angular element is advantageous. The fixing angular elements can be formed in one part or multiple parts.

The front and rear stiffening panel which can also be regarded as stiffening frames are advantageously relatively simple to produce, for example from a steel panel with a corresponding thickness, for example 8 mm. In principle the front and rear stiffening panel can also consist of two or more parts and be designed by means of welding to the frame-like stiffening panel.

The front and rear stiffening panel is usefully formed for a direct connection of vertical fixing profiles, for example 19″ profiles or profiles with a 25 mm matrix. The vertical fixing profiles are respectively arranged on the inner side and with their hole matrix in the access opening projecting over on the front and rear stiffening panel. Necessary holes and/or threads for e.g. 19″ or 23″ profiles can also be incorporated directly into the stiffening panels.

The panel-like side stiffening elements form a unit with the front and rear stiffening panel and then run parallel to the right and left cabinet or frame side.

It is advantageous that the side stiffening elements are provided on the edge with horizontal and vertical fixing areas. With these fixing areas the side stiffening elements are connected to the front and rear stiffening panel to form the inventive stiffening construction and with the horizontal fixing areas with the upper and lower depth profile of the base frame. Using the horizontal and vertical fixing areas which can usefully be formed on the edge on the side stiffening elements as chamfered areas or angled down areas, the inventive stiffening construction can be produced as a very stable reinforcing cage and a cabinet which is generally provided as a base cabinet can be equipped to form an earthquake cabinet. A change in the base frame is not necessary. High-resource weld constructions or assemblies of individual stiffening components can also be avoided.

A further advantage consists in the receiving area of the cabinet or rack not being reduced by the cage-like stiffening construction. Through the frame-like formation of the front and rear stiffening panel a good accessibility to the receiving area is guaranteed.

It is furthermore advantageous that the side stiffening elements can be formed on the right and left cabinet or frame side respectively as a one-part panel or also as multi-part panels. In case of a one-part panel-like formation the side stiffening elements extend from the front stiffening panel to the rear stiffening panel and from the upper depth strut to the lower depth strut.

The necessary earthquake resistance and load capacity of up to 800 kilograms can also be achieved with side stiffening elements which respectively consist of a panel but which is provided with broken-out areas so that a one-part, interrupted side stiffening element is formed. The broken-out areas are advantageously to be used for cables or cable guiding and facilitate accessibility from the cabinet side.

A plurality of panels can also be provided as side stiffening elements which are fixed horizontally and parallel to each other between the front and rear stiffening panel.

The invention is explained in further detail below using a drawing, which shows in:

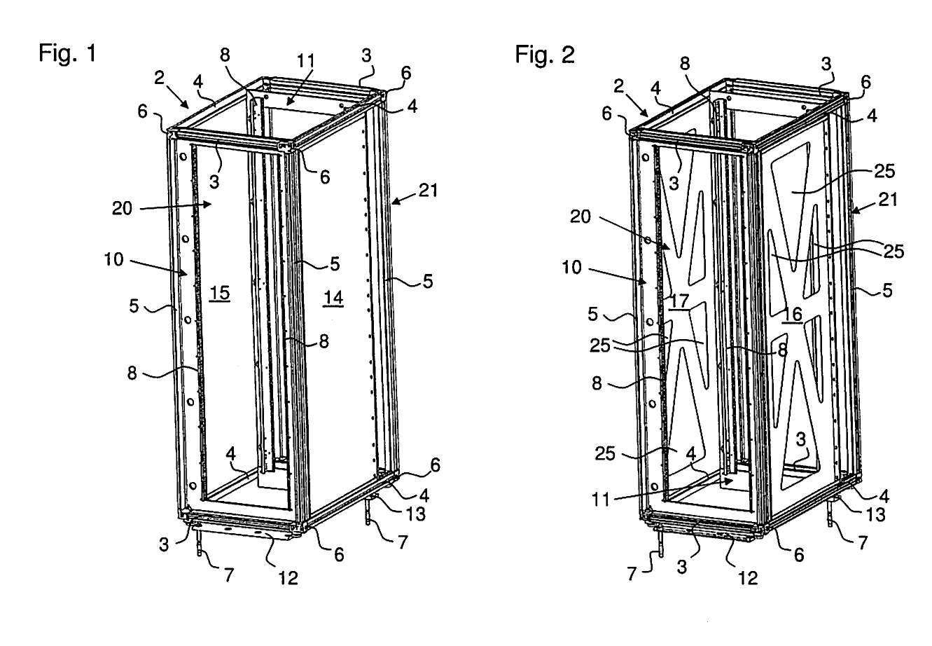

FIG. 1 a base frame of an inventive equipment cabinet with earthquake stiffening;

FIG. 2 a base frame of an inventive equipment cabinet with alternatively designed earthquake stiffening;

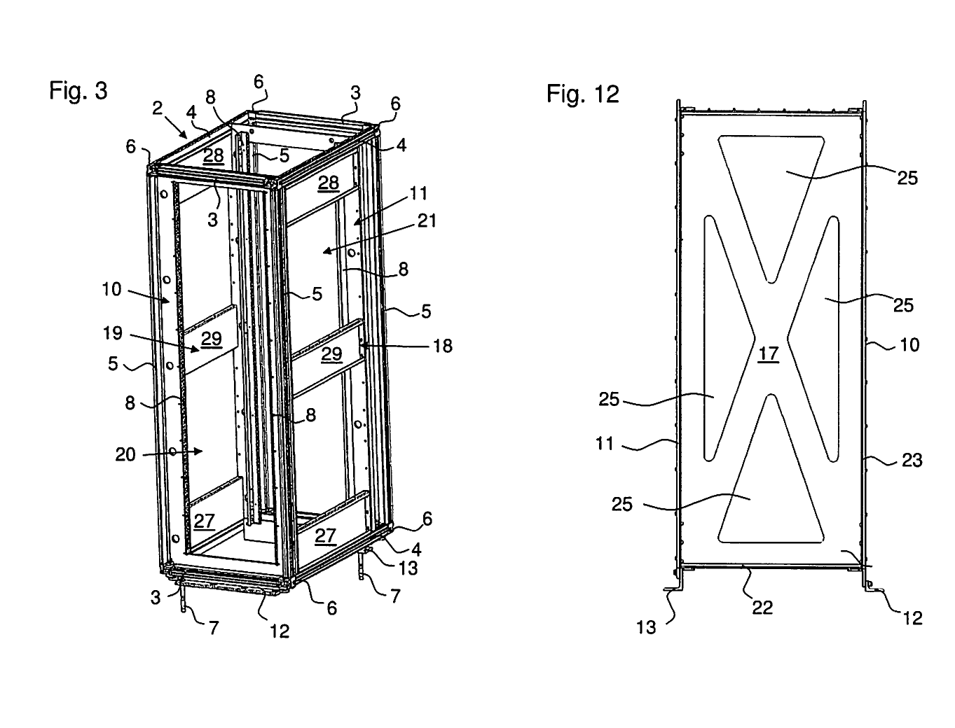

FIG. 3 a base frame of an inventive equipment cabinet with a further alternative formation of the earthquake stiffening;

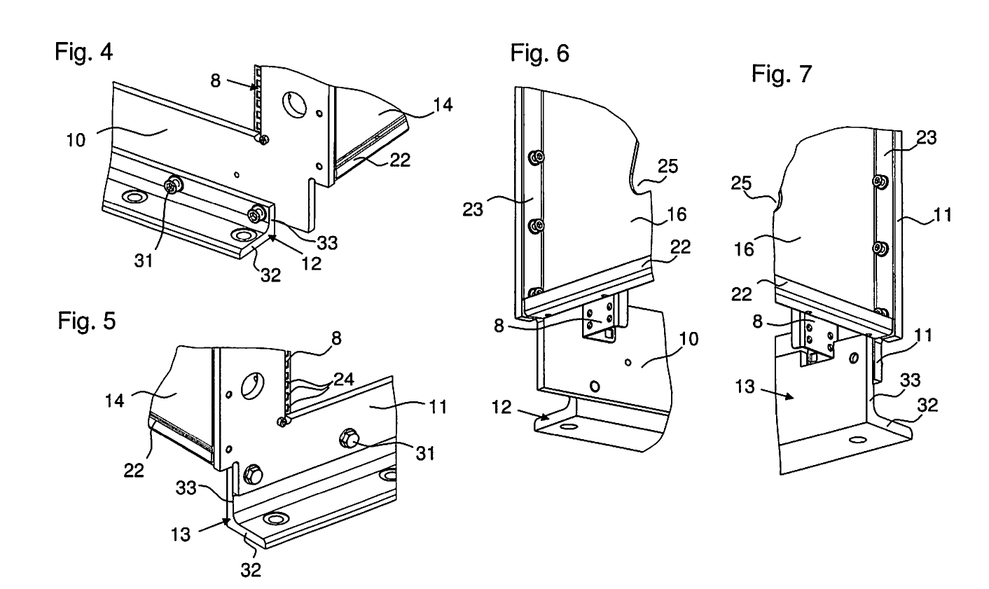

FIG. 4 a cut-out of the earthquake stiffening in the region of the front stiffening panel with front bottom fixing angular element;

FIG. 5 a cut-out of the earthquake stiffening in the region of the rear stiffening panel with rear bottom fixing angular element;

FIG. 6 a cut-out of the earthquake stiffening in the region of the right side stiffening and front stiffening panel;

FIG. 7 a cut-out of the earthquake stiffening in the region of the right side stiffening and rear stiffening panel;

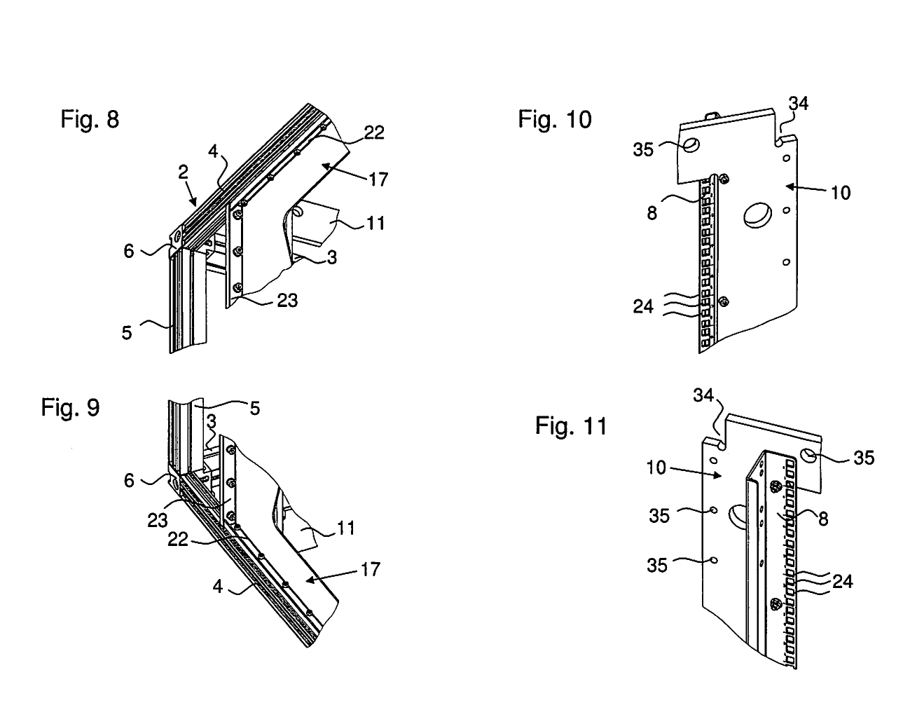

FIG. 8 a cut-out of the earthquake stiffening in the upper region of the left side stiffening;

FIG. 9 a cut-out of the earthquake stiffening in the lower region of the left side stiffening;

FIG. 10 a view of the upper region of the front stiffening panel from externally;

FIG. 11 a view of the upper region of the front stiffening panel from internally and

FIG. 12 a side view of an earthquake stiffening with interrupted side stiffening.

FIGS. 1 to 3 show alternative embodiments of the inventive earthquake stiffening for an equipment cabinet, of which only the base frame 2 comprising transverse profiles 3, depth profiles 4 and vertical profiles 5 arranged at right angles to each other and connected by means of corner connectors 6 is shown in FIGS. 1 to 3. The panelling parts of an equipment cabinet, a front door, a rear door or a rear wall, two side walls and an upper cover and a cabinet bottom or a cabinet base which are fixed to the base frame 2 are not shown.

The transverse profiles 3, depth profiles 4 and vertical profiles 5 as well as the corner connectors 6 of the base frame 2 are designed for a particularly high static and dynamic load and guarantee a maximum static carrying load of up to 800 kilograms.

While the base frame 2 can be made of aluminium or steel the earthquake stiffening within the base frame 2 is produced from steel panels which can have for example a thickness of approximately 8 mm.

According to FIG. 1 the earthquake stiffening comprises a front stiffening panel 10, a rear stiffening panel 11 and a right closed side stiffening element 14 and a left closed side stiffening element 15. The front stiffening panel 10 is provided with a bottom fixing angular element 12 and the rear stiffening panel 11 with a rear bottom fixing angular element 13, which respectively extend virtually over the whole breadth of the front and rear stiffening panel 10, 11, can be fixed with a horizontal bottom leg 32 to the floor of the installation space of the cabinet (not shown) and are releasably connected with a vertical leg 33 with the front or rear stiffening panel 10, 11 via screw connections 31 (see also FIGS. 4 to 7). Fixing elements 7 are shown by way of example for the fixing of the front and rear bottom fixing angular elements 12, 13 to the floor.

The front and rear stiffening panel 10, 11 are formed in the manner of a frame in the embodiments of FIGS. 1 to 3 and delimit a front access opening 20 or rear opening 21. Vertical fixing profiles 8, in the present embodiments 19″ profiles, are respectively fixed by means of screw connections (see also FIGS. 10 and 11) to the inner side of the front and rear stiffening panel 10, 11 in such a way that the matrix-like fixing openings 24 for the electrical and electronic components, for example servers (not shown), to be arranged in the cabinet project or protrude into the access openings 20, 21.

Closed side stiffening elements 14, 15 are arranged between the front stiffening panel 10 and the rear stiffening panel 11 in the earthquake stiffening of FIG. 1. Said side stiffening elements 14, 15 are formed as panels and extend from the front stiffening panel 10 to the rear stiffening panel 11 and from the bottom to the top depth profile 4. The connection of the right and left closed side stiffening element 14, 15 to the front and rear stiffening panel 10, 11 takes place by means of screw connections in the same way as the fixing of the right and left closed side stiffening elements 14, 15 to the respective top and bottom depth strut 4. The closed side stiffening elements 14, 15 are provided for this purpose with horizontal fixing areas 22 and vertical fixing areas 23 on their panel edges which can be formed as right angled chamfered areas or angled down areas (see also FIGS. 6 to 9).

The rear stiffening panel 11 is arranged at a distance from the rear side of the base frame 2 within the base frame 2. The space thus formed can be used for cable guiding.

The base frame 2 of FIG. 2 is identical to the base frame of FIG. 1. The front and rear stiffening panel 10, 11 with front and rear bottom fixing angular element 12, 13, fixing elements 7 and vertical fixing profiles 8 on the front and rear stiffening panel 10, 11 coincide with FIG. 1. In principle the same reference numerals are used for identical features.

The earthquake stiffening of the cabinet according to FIG. 2 differs in the side stiffening elements 16, 17 which are not formed as closed side stiffening elements according to FIG. 1 but instead as interrupted side stiffening elements 16, 17. The right interrupted side stiffening element 16 and the left interrupted side stiffening element 17 are also formed as panels but with broken-out areas 25 or recesses which allow cable guiding and accessibility to the inner space of the cabinet or the base frame 2. The interrupted side stiffening elements 16, 17 extend over the whole height of the base frame sides and are fixed to the upper and lower depth profiles 4.

Together with the front and rear stiffening panel 10, 11 a stiffening construction is also formed with respect to this earthquake stiffening, which constitutes a separate unit and can be subsequently built into a cabinet or a base frame. The releasably fixed bottom fixing angular elements 12, 13 on the front or rear stiffening panel 10, 11 have the advantage that higher-resource bottom fixtures are no longer required.

The earthquake stiffening shown in FIG. 3 comprises alternatively formed side stiffening elements 18, 19. The front and rear stiffening panel 10, 11 and the front and rear bottom fixing angular elements 12, 13 correspond to those of FIGS. 1 and 2. As multi-part side stiffening elements 18, 19 three horizontal panels, namely a lower panel 27, an upper panel 28 and a middle panel 29, are arranged in this embodiment, which respectively connect the front stiffening panel 10 to the rear stiffening panel 11. The right and left lower panel 27 is fixed with its lower horizontal fixing region 22 to the respective lower depth profile 4 while the right and left upper horizontal panel 28 is screwed with its upper horizontal fixing region on the respective upper depth profile 4 (see FIGS. 8 and 9). The vertical fixing regions 23 of the side stiffening elements 14 to 19 and thus also of the panels 27 to 29 of FIG. 3 serve for the connection to the front or rear stiffening panel 10, 11.

FIG. 4 shows a lower region of the front stiffening panel 10 from outside. The frame-like front stiffening panel 10 is supported on the front bottom fixing angular element 12 in that it is connected to the vertical leg 33 of the front bottom fixing angular element 12 via screw connections 31. On the inner side a vertical fixing profile 8 is arranged on the front stiffening panel 10 and on the outer side the right closed side stiffening element 14 can be seen with its horizontal fixing region 22 in a cut-out.

FIG. 5 shows a lower region of the rear stiffening panel 11 with vertical fixing profile 8 arranged on the inner side and projecting fixing openings 24. The deflection of the forces takes place via the rear bottom fixing angular element 13 into the floor of the cabinet installation space (not shown). The rear bottom fixing angular element 13 has a higher vertical leg 33 than the front bottom fixing angular element 12 (FIG. 4). The rear stiffening panel 11 is connected to the right closed side stiffening element 14 which is connected with its horizontal fixing region 22 in the incorporated state with the lower depth strut 4 of the base frame 2.

FIGS. 6 and 7 show the fixing of a right interrupted side stiffening 16 with a broken-out area 25 on the front or rear stiffening panel 10, 11. FIG. 6 shows the front stiffening panel 10, the vertical fixing profile 8 and the front bottom fixing angular element 12. The interrupted side stiffening element 16 lies with its vertical region 23 on the inner side on the front stiffening panel 10 and is screwed to this.

FIG. 7 shows the rear region of the interrupted right side stiffening 16 which is connected to the rear stiffening panel 11 with its vertical fixing region 23. A vertical fixing profile 8 and the rear bottom fixing angular element 13 are also fixed to the rear stiffening panel 11. In the incorporated state the interrupted right side stiffening element 16 lies with its horizontal fixing region 22 on a lower depth strut 4 of the base frame 2 and is fixed to it.

FIG. 8 reproduces the upper left rear corner region of the base frame 2. The rear stiffening panel 11 is arranged at a distance from the rear transverse profile 3 parallel thereto. The left interrupted side stiffening element 17 is connected via screw fixings in the vertical fixing region 23 with the rear stiffening panel 11 and via screw fixings in the horizontal fixing region 22 with the upper depth profile 4.

The cut-out of FIG. 9 shows the lower left rear corner region of the base frame 2 and the arrangement of the rear stiffening panel 11 and the fixing of the left interrupted side stiffening 17 on this rear stiffening panel 11 and on the lower depth profile 4.

FIG. 10 illustrates the formation of the front and rear stiffening panel 10, 11 with recesses 34 for arrangement within the base frame 2 (see FIGS. 1 to 3) and with various fixing bores 35 for fixing of the vertical fixing profiles 8 and the side stiffening elements 14 to 19 (see FIGS. 4 to 9).

FIG. 12 shows a view of an earthquake stiffening arrangement in the region of the left interrupted side stiffening 17 with alternatively formed broken out areas 25. The side stiffening 17 is connected to the front stiffening panel 10 and rear stiffening panel 11 in the region of the vertical fixing regions 23. The front bottom fixing angular element 12 is removably fixed to the front stiffening panel 10 and the rear bottom fixing angular element 11 is releasably fixed to the rear stiffening panel 11.

1. Equipment cabinet with earthquake stiffening which is arranged within a base frame of the equipment cabinet, wherein the base frame comprises transverse profiles, depth profiles and vertical profiles arranged at right angles to each other, on which as panelling parts a front and rear door or a rear wall, two side walls, an upper cover and a cabinet bottom can be fixed,
wherein the earthquake stiffening is formed as a separate body with a front and rear stiffening panel and side stiffening elements connecting them.

2. Equipment cabinet according to claim 1,
wherein the front stiffening panel and/or the rear stiffening panel is designed in the manner of a frame with the formation of a front or respectively rear access opening to form a receiving area of the equipment cabinet and is arranged parallel to the front or rear side of the framework.

3. Equipment cabinet according to claim 1,
wherein the front and rear stiffening panel is respectively fixed via bottom fixing angles to the bottom of the installation space of the cabinet.

4. Equipment cabinet according to claim 1,
wherein the side stiffening elements are formed to be panel-like and in one or more parts and arranged parallel to the right or left cabinet or frame side.

5. Equipment cabinet according to claim 1,
wherein the side stiffening elements comprise on the edge horizontal fixing regions and vertical fixing regions and the side stiffening elements can be fixed with the horizontal fixing regions on the upper or lower depth profile of the base frame and with the vertical fixing regions on the front stiffening panel and rear stiffening panel.

6. Equipment cabinet according to claim 4,
wherein the one-part side stiffening elements are formed as closed side stiffening elements or as interrupted side stiffening elements and respectively extend from the front stiffening panel to the rear stiffening panel and from the bottom to the top depth strut of the base frame).

7. Equipment cabinet according to claim 6,
wherein the one-part interrupted side stiffening elements comprise broken-out areas.

8. Equipment cabinet according to claim 4,
wherein the multi-part side stiffening elements comprise a plurality of horizontally arranged panels which are arranged as a lower panel, upper panel and middle panel.

9. Equipment cabinet according to claim 1,
wherein vertical fixing profiles which are equipped with fixing openings for fixing electrical and electronic module units can be fixed on the inner side on the front and rear stiffening panel.

10. Equipment cabinet according to claim 1,
wherein the front and rear stiffening panel and the side stiffening elements are produced from steel panels.
